(19) United States
(12) Patent Application Publication
(10) Pub. No.: US 2014/0028949 A1
(43) Pub. Date: Jan. 30, 2014

(54) Liquid Crystal Display Device, Backlight Module, and Backboard Structure

(71) Applicants: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(72) Inventors: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(73) Assignee: Shenzhen China Star Optoelectronics Technology Co., Ltd., Shenzhen (CN)

(21) Appl. No.: 13/582,999

(22) PCT Filed: Jul. 25, 2012
(86) PCT No.: PCT/CN12/79151

§ 371 Date: Sep. 6, 2012

(30) Foreign Application Priority Data
Jul. 24, 2012 (CN) 201210257725.X

(51) Int. Cl. G02F 1/13357; G09F 13/04; F21V 17/00

(52) U.S. Cl. 349/58; 362/433; 362/97.2

(57) ABSTRACT

The present invention discloses a liquid crystal display device, a backlight module incorporated, and a backboard structure configuring the backlight module. The backlight module includes a chassis configured with a holder and a fastening unit. The holder includes a bottom board, a tap, and a first sidewall. A receiving slot is jointly defined by the bottom board, the first sidewall and the tab to receive and position an optical module. The fastening unit includes a coverlid and a second sidewall. A positioning slot is jointly defined by the coverlid, the second sidewall and the tab to receive and position a side of a liquid crystal display panel. The chassis can be used to readily replace a conventional frontal frame and a plastic frame so as to reduce the manufacturing cost.

The present invention relates to a technology of liquid crystal display device, and more particularly, to a liquid crystal display device, its backlight module, and its backboard structure.

### BACKGROUND OF THE INVENTION

The liquid crystal display device is a very common device nowadays. As known to the art, the liquid crystal display device is typically configured with a backboard, a front frame, a plastic frame, an optical module, and a liquid crystal display panel. In that configuration, the front frame presses onto the liquid crystal display panel so as to securely position it from losing. The plastic frame is used to home and position the optical module, and also provides a solid support to the liquid crystal display panel. Accordingly, as to the current technology, the front frame and the plastic frame are vital and indispensible parts for the liquid crystal display device.

However, the front frame and the plastic frame have comparably high manufacturing cost. Accordingly, the including of the front frame and the plastic frame will inevitably increase the manufacturing cost of the liquid crystal display device. In addition, the tremendous exhaustion of the front frame and the plastic frame has also created some inconvenience to the assembly of the liquid crystal display device.

### SUMMARY OF THE INVENTION

It is the object of the present invention to provide a technical solution for providing a liquid crystal display device, a backlight module, and a backboard structure. The newly introduction of the backboard structure can readily replace the prior art front frame and the plastic frame. As a result, the newly designed backboard structure can readily reduce the manufacturing cost as well as eliminate any inconvenience during assembling related to the front frame and the plastic frame.

In order to resolve the technical issue encountered by the prior art, the present invention provides a technical solution by introducing a backboard structure for use with a backlight module, wherein the backboard structure includes a chassis which is configured with a holder configured with a bottom board, a first sidewall, and a tab, the bottom board being used to carry and support an optical module, and the first sidewall interconnected with the first sidewall, a top of the first sidewall interconnecting with the tab which is used to support a liquid crystal display panel, wherein the bottom board, the first sidewall and the tab jointly defined a receiving slot for receiving and positioning the optical module therein. And a fastening unit attached to the holder, and incudes a second sidewall and a cover lid, a bottom of the second sidewall interconnecting with the tab, and a bottom of the second sidewall interconnecting with the cover lid, wherein the second sidewall, and the tab jointly defining a positioning slot to receive and position the liquid crystal display panel.

Wherein there are a plurality of fastening units, and alternatively arranged across the tab of the holder.

Wherein there is a plurality of chasses articulated in a head-to-tail manner.

Wherein the backboard structure further includes a supporting unit arranged under the optical module so as to provide a support to the optical module.

Wherein there are a plurality of supporting unit alternatively arranged, both ends of the supporting units anchored onto a bottom board of the holder of the chassis.

Wherein the bottom board is defined with recess in a junction with respect to the first sidewall so as to create a heat dissipating space between the recess and the optical module.

Wherein a buffering area is created between the optical module and the first sidewalk a second buffering area is created between the liquid crystal display panel and the second sidewall.

Wherein a first buffering pad is arranged between the optical module and the tab so position and protect the optical module, wherein a second buffering pad is arranged between the liquid crystal display panel and the tab, and wherein a third buffering pad is arranged between the liquid crystal display panel and the cover lid.

In order to resolve the technical issue encountered by the prior art, the present invention provides a technical solution by introducing a backlight module, characterized in that the backlight module includes an optical module and a backboard structure which includes a chassis which comprises a holder configured with a bottom board, a first sidewall, and a tab, the bottom board being used to carry and support an optical module, and the first sidewall interconnected with the first sidewall, a top of the first sidewall interconnecting with the tab which is used to support a liquid crystal display panel, wherein the bottom board, the first sidewall and the tab jointly defined a receiving slot for receiving and positioning the optical module therein. A fastening unit is attached to the holder, and includes a second sidewall and a cover lid, a bottom of the second sidewall interconnecting with the tab, and a bottom of the second sidewall interconnecting with the cover lid, wherein the second sidewall, and the tab jointly defining a positioning slot to receive and position the liquid crystal display panel. And wherein the optical module is configured with a waveguide assembled with optical films, the receiving slot of the holder receives sides of the optical module to securely position the optical module.

Wherein there are a plurality of fastening units, and alternatively arranged across the tab of the holder.

Wherein there is a plurality of chasses articulated in a head-to-tail manner.

Wherein the backboard structure further includes a supporting unit arranged under the optical module so as to provide a support to the optical module.

Wherein there are a plurality of supporting unit alternatively arranged, both ends of the supporting units anchored onto a bottom board of the holder of the chassis.

Wherein the bottom board is defined with recess in a junction with respect to the first sidewall so as to create a heat dissipating space between the recess and the optical module.

In order to resolve the technical issue encountered by the prior art, the present invention provides a technical solution by introducing a liquid crystal display device which is configured with a liquid crystal display panel and a backlight module. Wherein a receiving Slot of the holder receives sides of the optical module to securely position the optical module.

Wherein there are a plurality of fastening units, and alternatively arranged across the tab of the holder.

Wherein there is a plurality of chasses articulated in a head-to-tail manner.

Wherein the backboard structure further includes a supporting unit arranged under the optical module so as to provide a support to the optical module.

Wherein there are a plurality of supporting unit alternatively arranged, both ends of the supporting units anchored onto a bottom board of the holder of the chassis.

The present invention provides an embodiment of liquid crystal display, a backlight module, and a backboard structure which includes a chassis configured with a holder and a fastening unit. The holder is used to home and position an optical module and a liquid crystal display panel. The chassis provided by the present invention can be used to replace a conventional front frame and a plastic frame. With the front frame and the plastic frame replaced, the cost of the backlight module and the liquid crystal display device incorporated with the backlight module is tremendously reduced as well. In addition, the backlight module also features a simplified configuration benefiting a smooth and convenient assembling of the backlight module and the liquid crystal display device.

### BRIEF DESCRIPTION OF DRAWINGS

FIG. 1 is a partial and cross sectional view of a liquid crystal display device incorporated with a backboard structure made in accordance with the present invention;

FIG. 2 is an illustrational view of as fastener shown in FIG. 1;

FIG. 3 is an illustrational and structural view of a backboard structure;

FIG. 4 is an illustrational and exploded view of a liquid crystal display device; and

FIG. 5 is an illustrational view of a liquid crystal display device shown in FIG. 4.

### DETAILED DESCRIPTION OF PREFERRED EMBODIMENTS

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings, and they should all be covered by the appended claims.

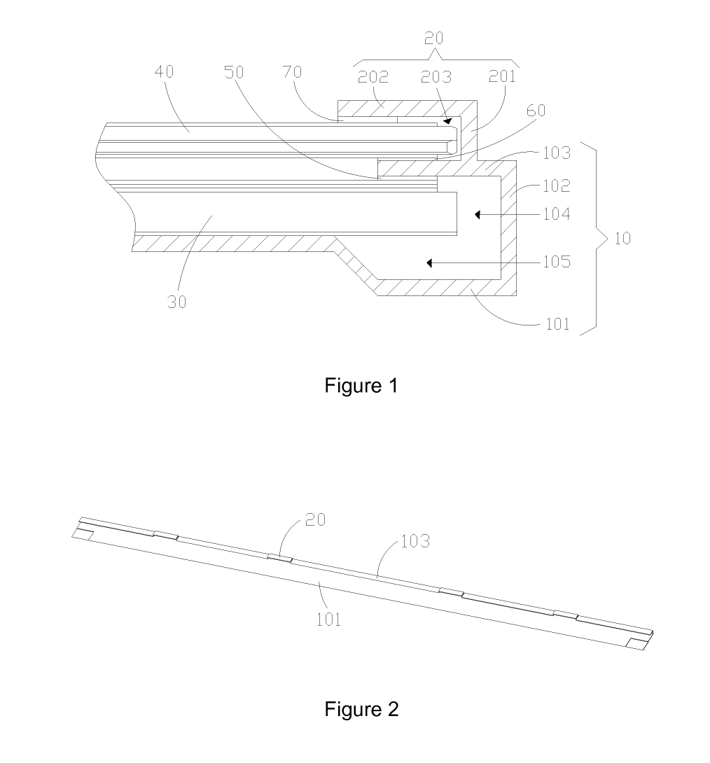

Referring now to FIGS. 1 and 2, in the current embodiment, a backboard structure made in accordance with the present invention includes a chassis which is configured with a holder 10 and a fastening unit 20. Detailed description of the holder 10 and the fastening unit 20 will be given here below.

The holder 10 includes a bottom board 101, a first sidewall 102 and a tab 103. Wherein the bottom board 101 is used to support an optical module 30, i.e. the optical module can be placed horizontally onto the bottom board 101. The first sidewall 102 is used to interconnect the bottom board 101 and the tab 103. Substantially, a bottom of the first sidewall 102 is interconnected to the bottom board 101, and a top of the first sidewall 102 is interconnected with the tab 103. The tab 103 serves with two purposes. Firstly, the tab 103 will press against the optical module 30; and secondly, the tab 103 will provide a support to a liquid crystal display panel 40. It can be readily seen that the bottom board 101, the first sidewall 102 and the tab 103 jointly define a receiving slot 104 in which the optical module 30 is received and positioned therein.

It should be noted that the holder 10 of the chassis should not be limited to what has been disclosed in drawing Figures. Substantially, the bottom board 101 is limited to a rectangular shape, while it can be embodied into a trapezoid or a curvilinear shape. It can even be embodied with a plurality or elongated board, as long as the optical module 30 can be readily supported. The first sidewall 102 can be an upright wall, and it can also be arranged in a tilted manner as long as it can securely interconnect the bottom board 101 and the tab 103. The shape of the first sidewall 102 can be designed with other alternatives, such as a plurality of erected columns. The shape of the tab 103 can also be designed according to field requirements with the same principle as applied to the bottom board 101.

Apparently, since the bottom board 101, the first sidewall 102 and the tab 103 can be nimbly arranged, as a result, the configuration of the receiving slot 104 will also changed accordingly, instead of remaining unchanged. In the currently embodiment, the receiving slot 104 has an U-shaped configuration, while in other embodiment, the receiving slot 104 can be implemented with other adequate shape. Accordingly, it should not be limited to that only embodiment. On the other hand, as long as the function of receiving and positioning the optical module 30, the configuration and features of the holder 10 should not be limited.

Furthermore, within the holder 10, a recess 105 is defined in a joint between the bottom board 101 and the first sidewall 102. The bottom board 101 will not in contact with the optical module 30 in the area adjacent to the recess 105. As a result, the recess 105 becomes a heat dissipating space.

In the current embodiment, a first buffering pad 50 is arranged between the optical module 30 and the tab 103. With the functioning of the first buffering pad 50, the optical module 30 can he readily protected and positioned, and as this is known to the skilled in the art, and no further description is given. In other alternative embodiment, the optical module 30 can be protected and secured with other suitable measurement, for example, the tab 103 can be implemented with soft material so as to provide a protection and securement. No limitation should be imposed here.

With the receiving slot 104 of the holder 10, the optical module 30 can be readily received and positioned. By this arrangement, the plastic frame can be omitted. Accordingly, the omission of the plastic frame can readily simplified the assembling of the liquid crystal display device as well as the backlight module. The manufacturing cost is therefore reduced.

The fastening unit 20 is arranged onto the holder 10, and includes a second sidewall 201 and a coverlid 202. The second sidewall 201 is used to interconnect the coverlid 202 and the tab 103. Substantially, a bottom of the second sidewall 201 is interconnected to the tab 103, and a top of the second sidewall 201 is interconnected to the coverlid 202. The coverlid 202, the second sidewall 201 and the tab 103 jointly define a positioning slot 203 so as to receive and position the liquid crystal display panel 40.

It should be noted that the configuration and shape of the second sidewall 201 and the coverlid 202 could be nimbly arranged according to the field requirements. For example, the second sidewall 201 can be embodied as a plurality erected columns and each is interconnected to the coverlid 202 and the tab 103. Meanwhile, the second sidewall 201 can be implemented into a tilted configuration, and the coverlid 202 can be implemented into a plurality of short-plate pressing against the liquid crystal display panel 40. Under the condition of without compromising the functions of the second sidewall 201 and the coverlid 202, its configuration, features and shape can be readily modified and changed according to the field requirements. As a result, the second sidewall 201 and the coverlid 202 cannot be limited to what have been disclosed in the drawing Figures.

In the current embodiment, a second buffering pad 60 is arranged between the liquid crystal display panel 40 and the tab 103, and a third buffering pad 70 is arranged between the liquid crystal display panel 40 and the cover lid 202. The functions and configuration of the second and third buffering pads 60, 70 are similar to the first buffering pad 50, as a result, no detailed description is given here below. It should be noted that the second and third buffering pads 60, 70 are not a necessary part of the present invention.

On the other hand, there is a buffering space (not labeled in Figure) is defined between the optical module 30 and the first sidewall 102. That is to say that a side of the optical module 30 is next to the first sidewall 102. Similarly, a second buffering space (not labeled in Figure) is also defined between the liquid crystal display panel 40 and the second sidewall 201. The first and second buffering spaces are both used to protect the optical part (optical module 30 or the liquid crystal display panel 40). For example, if the liquid crystal display panel is hit or suffered by external shock wave or vibration, it can prevent the panel from being damaged resulted from abrasion or friction. However, this is readily known to the skilled in the art, and not further description is given.

Other than the arrangement of the buffering space, alternative measurements can also be taken so as to reach the same result. For example, the first sidewall can be made from soft material, such as rubber or the like. No limitation should be exposed thereto.

In the current embodiment, there is a plurality of fastening units 20. According to the embodiment, there is a plurality of fastening units 20 alternatively arranged across the tab 103 of the holder 10. As clearly shown in FIG. 2, the bottom board 101 and the tab 103 are implemented as an elongated board, and those four fastening units 20 are alternatively arranged in different positions of the tab 103.

It should be noted that the number of the fastening units 20 has no limitation. It can be readily think about that there are four fastening units 20, or alternatively, it can be three (3) or five (5). It can even one fastening unit 20 if it suits its purpose. Similarly, the dimension of the fastening unit 20 has no limitation. For example, the fastening unit 20 disclosed in FIG. 2 can fully extend along the tab 103 so as to cover a larger area. Specially, the fastening unit 20 can be an integrally formed elongated configuration extending between ends of the tab 103.

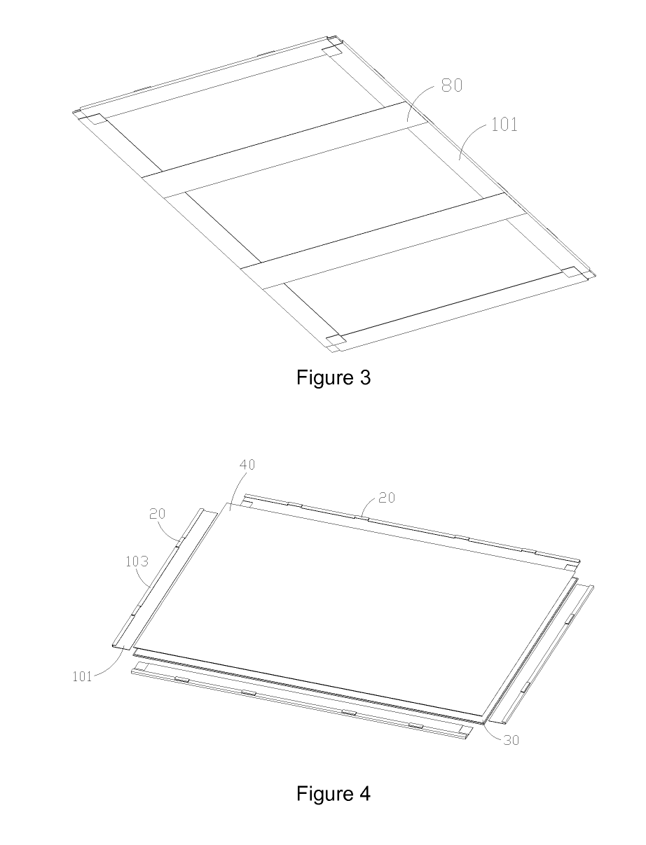

Referring to FIG. 3, in the current embodiment, there is a plurality of chasses and which are interconnected in a head-to-tail manner so as to configure a complete “backframe structure”. Substantially, the tour chasses are interconnected in head-to-tail to configure a “backframe”. In other embodiment, the number, shape and configuration of the chassis can be modified and changed so as to meet the field requirements. For example, the chassis can be made with an L-shaped configuration so as to configure a complete “backframe structure” with two L-shaped chasses. No limitation should be exposed onto this.

Other than the chassis, the backboard structure further includes a supporting element 80 disposed under the optical module so as to provide a solid support to the optical module 30. In the current embodiment, there are two support elements 80, and spaced apart from each other. Ends of the supporting element 80 are interconnected to the bottom board 101 of the chassis.

It can be readily understood that the supporting element 80 can be arranged with other shape and configuration. For example, the supporting element 80 can be arranged into a board having the same dimension with the optical module 30. Then the supporting element 80 are arranged and sandwiched between the optical module 30 and the bottom board 101 so as to support the optical module 30. Alternatively, the supporting element 80 can be implemented into a plurality of small pillars, such as shown in FIG. 3, which are arranged in a row on the chassis. Alternatively, the supporting element 80 can be embodied as at panel and securely attached to the bottom of the bottom board 101. Then embossments can be formed in a central area of the supporting element 80 so support the optical module 30. In addition, the supporting element 80 can be arranged in at “+” (cross) or “ [symbol] ” (field) configuration. However, this modification and variation can be readily done by the skilled in the art without spending much undue experiments. Accordingly, any variation in shape, dimension, shape and arrangement of the supporting element 80 should be cover by the appended claims.

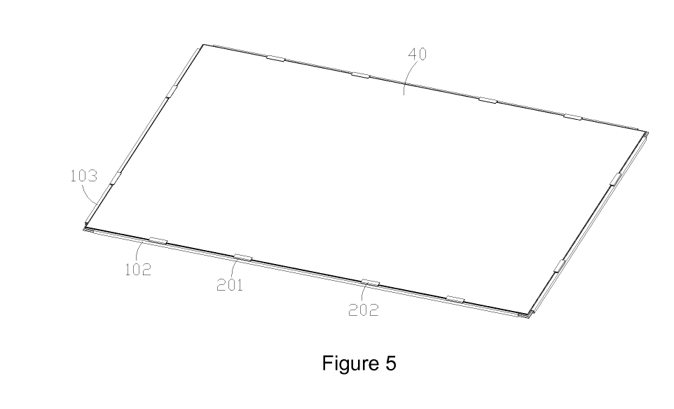

Referring to FIGS. 4 and 5, for easy understanding, assembling processes of the liquid crystal display device in accordance with the present invention is briefly described here below. In the current embodiment, the liquid crystal display device includes a chassis, a supporting element 80, an optical module 30, and a liquid crystal display panel 40. It should be noted that the following described is merely one of the suitable assembling process, and should not be construed as the whole contents of the current embodiment.

Firstly, preparing the optical module 30 and the liquid crystal display panel 40, four chasses, and two supporting elements 80;

Secondly, interconnecting three chasses into an U-shaped, but incomplete “back frame structure”;

Thirdly, installing the supporting elements 80 such that the supporting element 80 bridges on opposite sides of the U-shaped “backframe structure”.

Then sequentially assembling the optical module 30, and the liquid crystal display panel 40 into the U-shaped “backframe structure” from an opening of thereof, with the optical module 30 interengages with the receiving slot 104, and the liquid crystal display panel 40 engages with the positioning slot 203.

Lastly, attaching the last chassis of the four into the opening of the U-shaped “backframe structure”, and also interengages with the optical module 30 and the liquid crystal display panel 40.

In the first embodiment of the present invention, the chassis includes a holder 10 and a fastening unit 20. The receiving slot 104 of the holder 10 receives and positions the optical module 30, when the positioning slot 203 of the fastening unit 20 receives and positions the liquid crystal display panel 40. By this arrangement, a backboard structure configured with a chassis according to the first embodiment and the supporting element 80 can effectively reduce the use of the front frame and the plastic frame. In turn, it reduces the manufacturing cost of the backlight module and the liquid crystal display device. In addition, the chassis made in accordance with the first embodiment features a simplified configuration and can be easily manufactured. Accordingly, the chassis made in accordance with the present invention can readily brings up a great convenience of the backlight module and the liquid crystal display device.

According to another embodiment of the present invention, a backlight module is provided and which includes an optical module and a backboard structure as described above. The optical module includes a waveguide and optical films stacked thereupon. In general, the optical film is arranged on top of the waveguide, i.e. the optical films are supported by the waveguide. The backboard structure includes a chassis which includes a holder with a receiving slot thereof to receive and position a side of the optical module. Since the substantial configuration and structure of the backboard structure has been described above, not detailed description is given. On the other hand, the interactive arrangement of the backboard structure and the optical module has also been disclosed, and no detailed description is given repeatedly hereof.

In the current embodiment, the backlight module includes a backboard structure of previous embodiment. It can be readily appreciated that the backlight module is also benefited with low cost and convenience of assembling. Accordingly, the advantages brought up by the backboard structure can readily benefit the cost-down of the backlight module and the liquid crystal display device.

In the third embodiment, the present invention provides a liquid crystal display device which includes a backlight module disclosed in the previous embodiment. The backboard structure includes a chassis which includes a fastening unit with a positioning slot thereof to receive and position a side of a liquid crystal display panel. Since the substantial configuration and structure of the backboard structure and the backlight module have been described above, not detailed description is given.

It can be readily appreciated that when the liquid crystal display device is incorporated with the backlight module or the backboard structure, not only the assembling of the liquid crystal display device can be readily done, the manufacturing cost is also tremendously reduced.

The above described is merely a primary disclosure. In order to readily clarify the technical solution, and therefore implement that technical solution in view of the specification, a detailed description in view of a preferable embodiment in conjunction with accompanied drawings will be given here below. By this, other purposes, features and characteristics can be readily appreciated through the detailed description.

1. A backboard structure for use with a backlight module, wherein the backboard structure includes a chassis, including:
a holder configured with a bottom board, a first sidewall, and a tab, the bottom board being used to carry and support an optical module, and the first sidewall interconnected with the first sidewall, a top of the first sidewall interconnecting with the tab which is used to support a liquid crystal display panel, wherein the bottom board, the first sidewall and the tab jointly defined a receiving slot for receiving and positioning the optical module therein; and
a fastening unit attached to the holder, and including a second sidewall and a cover lid, a bottom of the second sidewall interconnecting with the tab, and a bottom of the second sidewall interconnecting with the cover lid, wherein the second sidewall, and the tab jointly defining a positioning slot to receive and position the liquid crystal display panel.

2. The backboard structure as recited in claim 1, wherein there is a plurality of fastening units, and alternatively arranged across the tab of the holder.

3. The backboard structure as recited in claim 1, wherein there is a plurality of chasses articulated in a head-to-tail manner.

4. The backboard structure as recited in claim 3, wherein the backboard structure further includes a supporting unit arranged under the optical module so as to provide a support to the optical module.

5. The backboard structure as recited in claim 4, wherein there are a plurality of supporting unit alternatively arranged, both ends of the supporting units anchored onto a bottom board of the holder of the chassis.

6. The backboard structure as recited in claim 1, wherein the bottom board is defined with recess in a junction with respect to the first sidewall so as to create a heat dissipating space between the recess and the optical module.

7. The backboard structure as recited in claim 1, wherein a buffering area is created between the optical module and the first sidewall, a second buffering area is created between the liquid crystal display panel and the second sidewall.

8. The backboard structure as recited in claim 1, wherein a first buffering pad is arranged between the optical module and the tab so position and protect the optical module, wherein a second buffering pad is arranged between the liquid crystal display panel and the tab, and wherein a third buffering pad is arranged between the liquid crystal display panel and the cover lid.

9. A backlight module, characterized in that the backlight module includes an optical module and a backboard structure which includes a chassis comprising:
a holder configured with a bottom board, a first sidewall, and a tab, the bottom board being used to carry and support an optical module, and the first sidewall interconnected with the first sidewall, a top of the first sidewall interconnecting with the tab which is used to support a liquid crystal display panel, wherein the bottom board, the first sidewall and the tab jointly defined a receiving slot for receiving and positioning the optical module therein; and
a fastening unit attached to the holder, and including, a second sidewall and a cover lid, a bottom of the second sidewall interconnecting with the tab, and a bottom of the second sidewall interconnecting with the cover lid, wherein the second sidewall, and the tab jointly defining a positioning slot to receive and position the liquid crystal display panel; and
wherein the optical module is configured with a waveguide assembled with optical films, the receiving slot or the holder receives sides of the optical module to securely position the optical module.

10. The backlight module as recited in claim 9, wherein there is a plurality of fastening units, and alternatively arranged across the tab of the holder.

11. The backboard structure as recited in claim 9, wherein there is a plurality of fastening units, and alternatively arranged across the tab of the holder.

12. The backboard structure as recited in claim 11, wherein the backboard structure further includes a supporting unit arranged under the optical module so as to provide a support to the optical module.

13. The backboard structure as recited in claim 12, wherein there are a plurality of supporting unit alternatively arranged, both ends of the supporting units anchored onto a bottom board of the holder of the chassis.

14. The backboard structure as recited in claim 9, wherein the bottom board is defined with recess in a junction with respect to the first sidewall so as to create a heat dissipating space between the recess and the optical module.

15. A liquid crystal display device, characterized in that the liquid crystal display device includes a backlight module recited in claim 9, wherein a receiving slot of the holder receives sides of the optical module to securely position the optical module.

16. The liquid crystal display device as recited in claim 15, wherein there is a plurality of fastening units, and alternatively arranged across the tab of the holder.

17. The liquid crystal display device as recited in claim 15, wherein there is a plurality of fastening units, and alternatively arranged across the tab of the holder.

18. The liquid crystal display device as recited in claim 17, wherein the backboard structure further includes a supporting unit arranged under the optical module so as to provide a support to the optical module.

19. The liquid crystal display device as recited in claim 18, wherein there are a plurality of supporting unit alternatively arranged, both ends of the supporting units anchored onto a bottom board of the holder of the chassis.
